(19) United States
(12) Patent Application Publication
(10) Pub. No.: US 2016/0216158 A1
(43) Pub. Date: Jul. 28, 2016

(54) INFRARED SENSOR

(71) Applicant: SHUN-LI YANG, Xiamen (CN)

(72) Inventor: SHUN-LI YANG, Xiamen (CN)

(21) Appl. No.: 14/605,579

(22) Filed: Jan. 26, 2015

(51) Int. Cl. G01J 5/08; G01J 5/10

(52) U.S. Cl. CPC G01J 5/0809; G01J 5/0806; G01J 5/10

(57) ABSTRACT

An infrared sensor includes a Fresnel lens, a rear casing, a reflecting mirror, a pyroelectric infrared sensor, a sensor circuit board, and a front casing. Therein, the rear casing is combined to the rear side of the front casing to form a sensor casing. The Fresnel lens is engaged on the upper surface of the front casing. The sensor circuit board is internally disposed in the sensor casing, with the pyroelectric infrared sensor installed on the sensor circuit board. The reflecting mirror is disposed on the upper part of the pyroelectric infrared sensor and beneath the Fresnel lens. Therefore, the present invention enlarges the sensing angle from 110 degrees to 220 degrees, such that the sensing scope is enlarged, the blind area is decreased, and the overall utility is enhanced.

### BACKGROUND OF THE INVENTION

1. Field of the Invention

The present invention relates to sensors, and more particularly, to an infrared sensor.

2. Description of the Related Art

Reflecting mirror is an optical component based on the law of reflection. Reflecting mirrors are categorized according to the shapes thereof into flat reflectors, spherical reflectors, and non-spherical reflectors. With different reflection levels, reflecting mirrors are further categorized into totally reflecting mirrors and half reflecting mirrors (beam splitter mirror). Regarding conventional manufacturing process, a glass component is plated with silver. In the standard process, a highly-polished substrate is processed with aluminum in a manner of vacuum plating, and subsequently plated with silicon oxide or magnesium fluoride. In the specific application, the lost caused by the metal material is allowed to be substituted with dielectric coating. Due to the law of reflection irrelevant with the frequency of light, the optical bandwidth of such components is extensive, reaching the bandwidth area of ultraviolet and infrared ray, such that the application scope of such components becomes more and more extensive. On the rear face of the optical glass, a component is provided in a form of a thin silver (or aluminum) layer plated by vacuum plating, thereby reflecting the incident light. Reflecting mirror with high reflectance is allowed to be applied for almost doubling the output efficiency of laser. With the reflection provided by the first reflecting face based on the front face reflection, the reflected image is prevented from being distorted and double imaged. If a conventional reflecting mirror as a second reflecting face, the reflection rate is lower, and the selectivity upon the wavelength does not exist; In addition, double image easily occurs. Also, with a plated reflector, the image acquired not only has high luminance, but also is accurate without aberration; in addition, the quality is much clearer and more colorful. The front face reflecting mirror is widely applied for keeping the image fidelity and scanning reflection imaging.

With the scientific development, normal reflecting mirror no longer satisfies the industrial demand nowadays. Various situations require an infrared reflecting mirror, such as an infrared sensor. However, referring to FIG. 1, the existing infrared sensor is able to sense only within an angle of 110 degrees. Thus, an object placed on a position out of the range of said 110 degrees is unable to be sensed.

### SUMMARY OF THE INVENTION

For improving the aforementioned issues, the present invention provides an infrared sensor, comprising:

a Fresnel lens;

a rear casing;

a reflecting mirror:

a pyroelectric infrared sensor;

a sensor circuit board; and

a front casing,

wherein the rear casing is combined to the rear side of the front casing to form a sensor casing, the Fresnel lens is engaged on the upper surface of the front casing, and the sensor circuit board is internally disposed in the sensor casing, with the pyroelectric infrared sensor installed on the sensor circuit board, while the reflecting mirror is disposed on the upper part of the pyroelectric infrared sensor and beneath the Fresnel lens.

Preferably, two outer sides and two ends of the Fresnel lens are provided with a rubber pad, respectively, so as to prevent the Fresnel lens from being damaged due to the shock during transportation.

Preferably, at least a part of the reflecting mirror is placed on the path of the infrared ray projected from the pyroelectric infrared sensor.

Preferably, the rear casing is screwed to the rear side of the front casing by use of screw members.

Preferably, the reflecting mirror is plated with a polished silver surface for specifically reflecting infrared rays.

Preferably, the reflecting mirror is formed of multiple reflecting faces.

With such a configuration, the present invention is provided with advanced structures, wherein the upper part of the infrared sensor has a reflecting mirror, thereby enlarging the sensing angle from 110 degrees to 220 degrees. Therefore, the sensing scope is enlarged, the blind area is decreased, and the overall utility is enhanced.

### BRIEF DESCRIPTION OF THE DRAWINGS

FIG. 1 is a schematic view illustrating the sensing angle of conventional products.

FIG. 2 is an exploded view of the infrared sensor with the reflecting mirror in accordance with the present invention.

FIG. 3 is a schematic view illustrating the structure of the Fresnel lens in accordance with the present invention.

FIG. 4 is a schematic view illustrating the sensing angle of the infrared sensor in accordance with the present invention.

FIG. 5 is a schematic view illustrating the operational method of the present invention.

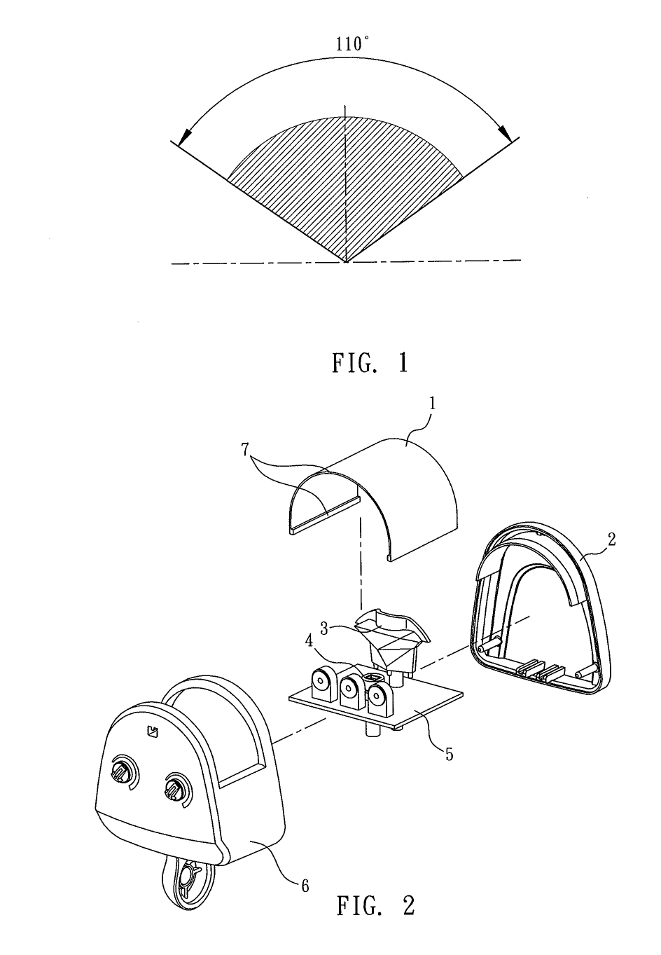

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

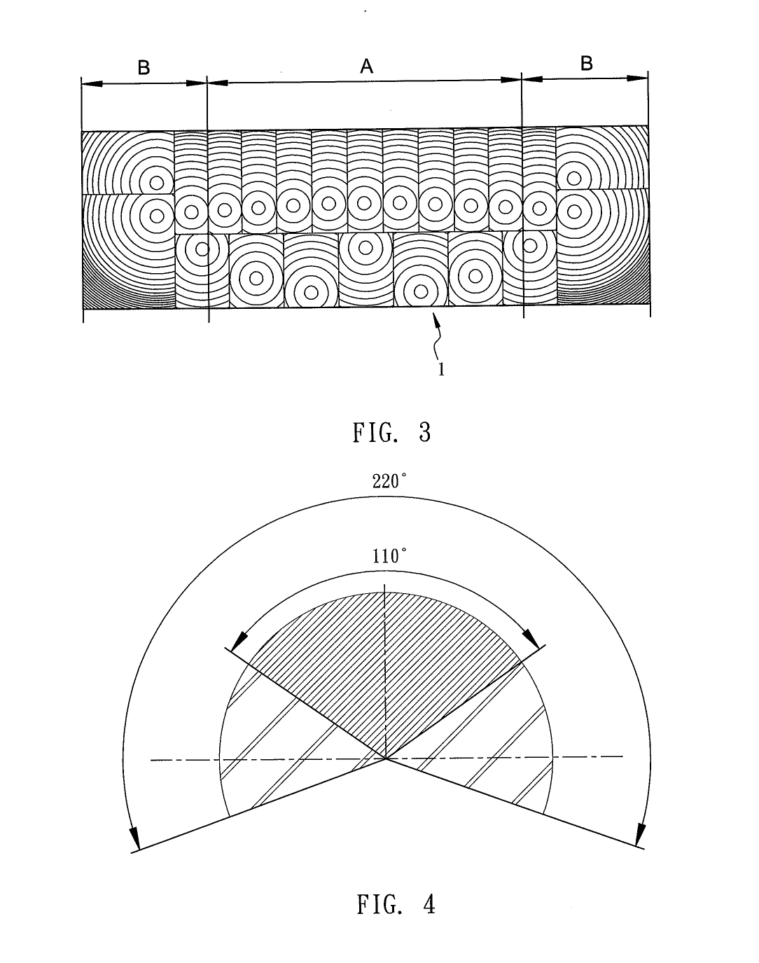

Referring to FIG. 2, the present invention provides an infrared sensor, comprising a Fresnel lens 1, a rear casing 2, a reflecting mirror 3, a pyroelectric infrared sensor 4, a sensor circuit board 5, and a front casing 6. The rear casing 2 is combined to the front casing 6 to form a sensor casing. The Fresnel lens 1 is engaged on the upper surface of the front casing 6, and the sensor circuit board 5 is internally disposed in the sensor casing, with the pyroelectric infrared sensor 4 installed on the sensor circuit board 5. The reflecting mirror 3 is disposed on the upper part of the pyroelectric infrared sensor 4 and beneath the Fresnel lens 1.

Therein, two outer sides and two ends of the Fresnel lens 1 are provided with a rubber pad 7, respectively, so as to prevent the Fresnel lens 1 from being damaged due to the shock during transportation.

The rear casing 2 is screwed to the rear side of the front casing 6 by use of screw members.

The reflecting mirror 3, in the embodiment provided by the present invention, is formed of multiple reflecting faces 8, and at the same time is a reinforced laminated glass with a reflecting layer plated in the lamination thereof. In the preferred embodiment, the plated reflecting layer is a silver layer. Also, at least a part of the reflecting mirror 3 is placed on the path of the infrared ray projected from the pyroelectric infrared sensor 4.

Referring to FIG. 3, area A is a 110-degree sensing area, and area B is an additional reflected area. In the situation of no reflecting mirrors provided, only objects within the 110-degree area A are allowed to be sensed. When reflecting mirrors are additionally provided, objects within the scope of both area A and area B are allowed to be sensed.

Referring to FIG. 4, the present invention is added with a reflecting mirror 3, so as to enlarge the sensing angle from 110 degrees to 220 degrees.

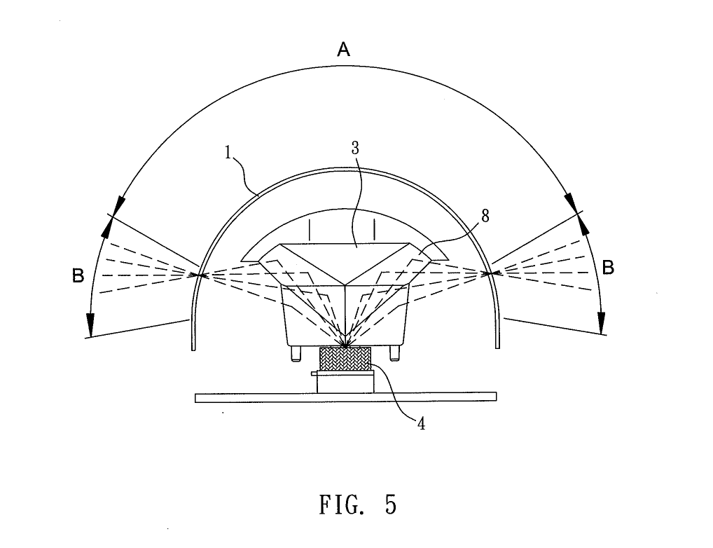

Referring to FIG. 5, the area B on the both sides of area A is an enlarged sensing angle due to the additional disposition of the reflecting mirror 3. The infrared ray enters from the sensing point of the pyroelectric infrared sensor 4 through the reflecting mirror 3, and subsequently reflected by the Fresnel lens 1, such that the reflecting angle thereof is the sum of the angle covered by both the area A and the area B. If the reflecting mirror 3 is not provided, the sensing angle shall only be the angle covered by the area A. In the preferred embodiment, the front edge of the reflecting mirror 3 is in alignment with the center of the pyroelectric infrared sensor 4, thereby allowing half of the infrared beam to be directly projected to the Fresnel lens 1 corresponding to the area A, while the other half of the infrared beam is reflected by the reflecting mirror 3 to the Fresnel lens 1 corresponding to the area B.

The pyroelectric infrared sensor 4 in the present invention is made according to the reflection theorem of infrared. The embodiment of the present invention is allowed to be an automatic tap, automatic hand drier, medical hand washer, automatic soap dispenser, automatic urinal flusher, induction or automatic commode. Such a device is operated based on infrared reflection law. When a hand or a body part is in the infrared area, the infrared ray projected by the infrared projector is blocked by the hand or body part and thus reflected to the infrared receiver. The signal processed by a microcomputer in an integrated circuit is next transmitted to a pulse electromagnetic valve, whereby the pulse electromagnetic valve, after receiving the signal, turns on the valve core according to a predetermined instruction for the tap to offer water. When the hand or body part leaves the infrared sensing range, the electromagnetic valve stops to receive the signal, such that the valve core therein is restored to the original position by an internal spring member, so as to turn off the tap water.

Regarding the applications of the pyroelectric infrared sensor 4 (intelligent infrared power-saving switch), the pyroelectric infrared sensor 4 is a high technological product. The pyroelectric infrared sensor 4 is power-saving, environment friendly, which is a perfect substitution of conventional acoustic-controlled or light-controlled products. Through the radiation reflected by human body, applications of the present invention are capable of activating different equipment such as lamps, alarms, and automatic doors. Especially, the present invention is applicable in middle class or high class hotels, apartments, enterprises, malls, path ways, or corridors. The activating method thereof is chosen between a one-time activation and a continuous activation.

As for application upon a lamp device, when detecting the infrared spectrum variation of the human body, power of the device is activated, and the loading is continuously turned on before the human body leaves the sensing scope. When the human body leaves the sensing scope, the loading is turned off after a certain delay. In other words, when a person enters the sensing scope, the device is activated; when a person leaves the sensing scope, the device is deactivated. Therefore, the present invention is convenient and power-saving, presenting a humanity property. The intelligent infrared power-saving switch is activated by the infrared heat emitted by the human body when someone passes the sensing scope, rather than being activated by sound, thereby controlling the activation of the lamp. When the person leaves, the lamp is turned off after a certain delay. Because the lamp device is not activated by sound, noise harassment is prevented. Also, due to the controlling by use of infrared heat emitted by the human body, power wasted is avoided, being power-saving and economical.

The most applied illumination devices in public space (such as public corridors or stairway) nowadays are lamps with acoustic controlled switch and delay mechanism. Such lamps and switches achieved the concept of “light up for people”, and become the most popular products for public illumination. Surely, such products in a certain degree provide the advantage of power-saving; however, such products cause certain harassment upon the environment. Due to the limitation of the products, the acoustic lamps and switches require a voice louder than 60 decibel, which causes voice pollution upon the quiet environment. With the social development and the manner of people gradually valuing the ecological environment, such acoustic controlled lamps and switches fail to meet the requirement of people. As a result, a more power-saving and environmental friendly automatic illumination device is need, so as to fulfill the demand of people for acquiring a high-quality life. The intelligent infrared power-saving switch is based on a platform of the matured infrared sensing technique. With more high technologies and technical advancements combined, a high end product with commercial outlook such as the present invention is thereby formed. The automatic controlling mechanism in the present invention overcomes the disadvantage of conventional acoustic controlling mechanism that requires voice which causes noise pollution. The automatic controlling mechanism of the present invention only requires the infrared heat emitted by human bodies when someone passes the sensing scope to be activated. Furthermore, more advanced technologies are combined in the present invention, so as to produce a more power-saving and more environmental friendly product.

Therein, the automatic infrared sensor provided by the present invention is allowed to be used on automatic illumination devices and exhaust fan devices in places such as corridors, pathways, store houses, garages, basements, and toilets, truly achieving a modernized intelligent management upon buildings and properties. The present invention provides following functions. First, when a person enters the sensing scope, the infrared sensor detects the variation of the infrared spectrum of the human body, such that the loading is automatically turned on. If the person keeps staying and acting in the sensing scope, the switch of the device applying the present invention is continuously turned on. When the person leaves the sensing scope, the switch is automatically turned off after a certain delay. Therefore, the present invention is power saving. Second, the present invention is provided with voltage calibration, applying a non-contact switch, thus extending the service life of the product. Third, a photosensitive controlling mechanism is applied, whereby the switch automatically detect a light source to be turned on. Also, when the light source is weak or insufficient, the switch is prevented from being accidentally activated.

Example illustrating the installation consideration of the present invention is provided as following:

1. Due to the sensing scope on the left and right sides being larger than the sensing scope on the upper and lower sides, the switch is preferred to be installed with the transverse axis thereof perpendicular to the walking direction of people, so as to acquire the greatest sensing performance.

2. When the switch is electrified after installation, with the environmental light source being sufficient, the lamp shall flash for three times. One minute later, the initial operation is finished, and the switching enters a sensing status. The light source is then covered for triggering the switch to start working. When the person keeps staying and acting in the sensing scope, the switch is continuously turned on; when the person leaves the sensing scope, loading of the switch is automatically turned off after a certain delay.

3. When the switch is electrified after installation, with the environmental light source being insufficient, the switch directly enters the sensing status. When the person keeps staying and acting in the sensing scope, the switch is continuously turned on.

Although particular embodiments of the invention have been described in detail for purposes of illustration, various modifications and enhancements may be made without departing from the spirit and scope of the invention. Accordingly, the invention is not to be limited except as by the appended claims.

1. An infrared sensor, comprising:
a Fresnel lens;
a rear casing;
a reflecting mirror;
a pyroelectric infrared sensor,
a sensor circuit board; and
a front casing,
wherein the rear casing is combined to the rear side of the front casing to form a sensor casing, the Fresnel lens is engaged on the upper surface of the front casing, and the sensor circuit board is internally disposed in the sensor casing, with the pyroelectric infrared sensor installed on the sensor circuit board, and the reflecting mirror is disposed on the upper part of the pyroelectric infrared sensor and beneath the Fresnel lens;
the Fresnel lens further comprising at least a first area and at least a second area, wherein the pyroelectric infrared sensor directly senses an infrared ray passing through the first area and at the same time senses another infrared ray passing through the second area and reflected by the reflecting mirror.

2. The infrared sensor of claim 1, wherein two outer sides and two ends of the Fresnel lens are provided with a rubber pad, respectively.

3. The infrared sensor of claim 1, wherein at least a part of the reflecting mirror is placed on the path of the infrared ray projected from the pyroelectric infrared sensor.

4. The infrared sensor of claim 1, wherein the rear casing is screwed to the rear side of the front casing by use of screw members.

5. The infrared sensor of claim 1, wherein the reflecting mirror is plated with a polished silver surface for specifically reflecting infrared rays.

6. The infrared sensor of claim 1, wherein the reflecting mirror is formed of multiple reflecting faces.

7. The infrared sensor of claim 1, wherein the Fresnel lens comprises one first area and two second areas, the two second areas disposed on two sides of the first area.
